(19) United States
(12) Patent Application Publication
(10) Pub. No.: US 2026/0361257 A1
(43) Pub. Date: Nov. 12, 2026

(54) NIGHT-SKY THERMORADIATIVE POWER GENERATION USING E_coh-MATCHED GRAPHENE RESONANT-TUNNELLING DIODES

(71) Applicant: Jonathan Washburn, Austin, TX (US)

(72) Inventor: Jonathan Washburn, Austin, TX (US)

(21) Appl. No.: 19/672,442

(22) Filed: May 8, 2026

Related U.S. Application Data
(60) Provisional application No. 63/804,606, filed on May 12, 2025.

(51) Int. Cl. H02S 10/30

(52) U.S. Cl. CPC H02S 10/30

(57) ABSTRACT

A thermoradiative generator that converts ambient heat into electrical power by radiating mid-infrared photons to the cold night sky. The generator includes a graphene/hexagonal-boron-nitride/graphene resonant-tunnelling diode configured for emission in a mid-infrared band coupled to the atmospheric transparency window, an optical cavity optically coupled to the resonant-tunnelling diode, and a reflector configured to direct emitted radiation skyward. In preferred embodiments, the peak emission energy is about 0.18 eV and the optical cavity thickness equals a coherence length of the emission. Representative embodiments provide nighttime electrical generation from ambient heat without auxiliary cooling or mechanical tracking.

### CROSS-REFERENCE TO RELATED APPLICATIONS

This application claims priority to U.S. Provisional Patent Application No. 63/804,606, filed May 12, 2025, the entire contents of which are hereby incorporated by reference herein.

### BACKGROUND OF THE INVENTION

The present disclosure relates generally to thermoradiative energy conversion and, more particularly, to mid-infrared thermoradiative generators employing graphene/hexagonal-boron-nitride/graphene resonant-tunnelling diode structures engineered for coherence-matched emission into the 8-14 micrometer atmospheric transparency window to generate electrical power at night from ambient heat.

Thermoradiative cells operate in a manner complementary to photovoltaic cells. Rather than converting incident solar photons into electrical output, a thermoradiative device emits photons from a warmer body to a colder radiative sink, such as the night sky, thereby driving charge carriers against a chemical potential and producing electrical power. For a thermoradiative device operating between a cell temperature T_cell and a colder sky temperature T_sky, the ideal efficiency is bounded by Carnot efficiency according to eta_Carnot=1−T_sky/T_cell.

Existing thermoradiative technologies suffer from several important limitations. Narrow-gap semiconductor systems based on indium antimonide (InSb), with a bandgap of about 0.23 eV, experience strong Auger recombination at approximately room temperature, which substantially reduces radiative quantum efficiency and limits practical power output. Reported output values for such systems are on the order of 13 W/m\hat{ }2. Mercury cadmium telluride systems, for example Hg0.8Cd0.2Te with a bandgap of about 0.11 eV, suffer from even more severe Auger-related losses, exhibit reported output values on the order of 9 W/m\hat{ }2, and further present toxicity and fabrication-compatibility concerns arising from mercury and cadmium content.

Conventional thermoradiative devices also suffer from angular and spectral losses. Isotropic emitters direct a substantial fraction of their radiated power away from the sky-coupled hemisphere, while emission outside the 8-14 micrometer atmospheric window is strongly attenuated by atmospheric absorption from species such as water vapor and carbon dioxide. Approaches using photonic crystals, tracking optics, or other bulk directional structures can improve coupling, but they tend to increase cost, complexity, form factor, and implementation burden, and may introduce moving parts or alignment requirements that are undesirable in compact night-power systems.

Additional limitations arise from the absence of prior systems that combine, in a single thermoradiative architecture, emission at a structurally derived energy, negligible or suppressed Auger loss, a directional optical cavity matched to emission coherence length, CMOS-compatible fabrication, and ledger-neutral E_coh-locked electrical extraction. As a result, prior thermoradiative systems have not provided a compact, manufacturable, no-moving-parts night-power architecture that preserves strong sky-coupled radiative transfer together with useful electrical output at ambient conditions.

Accordingly, there remains a need for a compact, CMOS-compatible, no-moving-parts thermoradiative generator capable of producing useful nighttime electrical output from ambient heat while suppressing dominant prior-art loss mechanisms. There further remains a need for a thermoradiative architecture that combines mid-infrared emission in a band coupled to the atmospheric transparency window, low-loss carrier dynamics, directional optical coupling, manufacturable device structure, and practical electrical energy extraction.

The present disclosure addresses these needs with a night-sky thermoradiative generator centered on a graphene/hexagonal-boron-nitride/graphene resonant-tunnelling diode, an optical cavity matched to the coherence characteristics of the diode emission, and a sky-facing reflector or metasurface configured to direct emitted radiation upward into the atmospheric transparency window. In preferred embodiments, the disclosure further provides a structurally determined coherence-linked emission energy, coherence-length matching of the cavity, and a synchronized electrical extraction architecture.

### SUMMARY OF THE INVENTION

The present disclosure provides a thermoradiative generator configured to convert ambient heat into electrical power by radiating mid-infrared photons to the cold night sky. In one aspect, the generator includes a graphene/hexagonal-boron-nitride/graphene resonant-tunnelling diode configured for mid-infrared emission, an optical cavity matched to the coherence characteristics of that emission, and a sky-facing reflector or metasurface configured to direct emitted radiation into the atmospheric transparency window. In this manner, the device produces electrical output from nighttime radiative exchange without auxiliary cooling or mechanical tracking.

In another aspect, the resonant-tunnelling diode is configured for peak emission in a mid-infrared energy band coupled to the atmospheric transparency window, the cavity dimension is selected to improve spectral and/or angular coupling of emitted radiation into that window, and the reflector is configured to direct at least a majority of emitted radiation skyward, and in preferred embodiments at least 80% of emitted radiation skyward. This intermediate technical framing preserves a broad device concept while remaining anchored to the disclosed atmospheric-window-coupled thermoradiative mechanism.

In preferred embodiments, the coherence quantum E_coh is given by E_coh=phi\hat{ }-5, the preferred peak emission energy is 0.18 eV=2×E_coh=2phi\hat{ }-5, and the cavity thickness is matched to the coherence length of the diode emission according to t_cavity=L_E_coh. In a preferred implementation, the cavity thickness is about 3.2 micrometers, the resonant-tunnelling barrier thickness is about 1.6 nm, the cavity comprises a patterned SiO2 structure, and the reflector comprises a TiN Salisbury-screen structure. The disclosure further presents the preferred 0.18 eV value as the smallest even-integer multiple of E_coh whose broadened emission lies in the useful atmospheric window under the disclosed lineshape.

The disclosure thus supports a layered hierarchy of embodiments. In broader embodiments, the invention is defined by a graphene/hexagonal-boron-nitride/graphene resonant-tunnelling diode, an optical cavity selected in relation to coherence characteristics of emission from the diode, and a reflector configured to direct emitted radiation skyward for nighttime thermoradiative power generation. In intermediate embodiments, the diode is configured for peak emission in a mid-infrared band coupled to the atmospheric transparency window, for example in an energy range of about 0.15-0.25 eV, the cavity dimension is selected to improve spectral coupling, angular coupling, or both spectral coupling and angular coupling of emitted radiation into the atmospheric window, and the reflector is configured to direct at least a majority, and preferably at least 80%, of emitted radiation skyward. In preferred embodiments, E_coh=phi\hat{ }-5, the peak emission energy is 0.18 eV=2×E_coh=2phi\hat{ }-5, and the cavity thickness equals the coherence length of emission, such that t_cavity=L_E_coh=3.2 micrometers.

In some embodiments, the disclosed architecture provides a directionality factor of about 5.6, hemispherical emissivity of about 0.83 over the 8-14 micrometer band, and electrical power density of about 35 W/m\hat{ }2 at an ambient temperature of about 300 K under clear night-sky conditions. A representative 4 cm\hat{ }2 tile embodiment provides about 15.3 mW output. In further embodiments, the device achieves about 24% of the Carnot limit for delta T less than or equal to 50 K.

In further embodiments, the thermoradiative generator is coupled to an electrical extraction circuit configured to harvest output from one or more devices. In preferred embodiments, energy extraction is synchronized to an eight-tick cadence, switching events are constrained to permitted phase windows, energy is transferred in integer multiples of E_coh, and a delta-ledger watchdog is configured to disable the converter when a monitored imbalance exceeds a threshold. These extraction features may be implemented in single-device, multi-device, series, parallel, or mixed interconnection arrangements.

In additional embodiments, the disclosure provides fabrication methods including graphene growth, dry transfer onto hexagonal boron nitride, mesa lithography, cavity patterning, reflector deposition, and thermocompression bonding. Module-level implementations, regulated output architectures, and downstream night-power systems may also be provided, including sensor nodes, hybrid day-night power systems, spacecraft embodiments, and polar-night beacon systems.

In still further embodiments, the disclosed devices exhibit measured or supported performance including about 35 W/m\hat{ }2 power density, about 24% Carnot fraction, about 2.3% power reduction after 1000 hours at 85 C and 85% relative humidity, and projected operational lifetime of at least about 15 years at 25 C based on Arrhenius extrapolation. The disclosure also preserves formal verification support for specific structural propositions including the coherence exponent relation, eight-phase cancellation, ledger neutrality, and related exact derived relationships.

### BRIEF DESCRIPTION OF THE DRAWINGS

FIG. 1 is a schematic perspective view of a thermoradiative generator showing a graphene/hexagonal-boron-nitride/graphene resonant-tunnelling diode, a coherence-matched optical cavity, a sky-facing reflector or metasurface, a thermal input path from ambient heat, and an upward radiative emission path into the atmospheric transparency window.

FIG. 2 is a cross-sectional view of a representative device stack showing a first graphene layer, a hexagonal boron nitride barrier, a second graphene layer, a resonant-tunnelling region, a patterned cavity structure, a reflector layer, an air-gap region, and a thermal coupling structure including bumps and a heat spreader.

FIG. 3 is an energy-alignment diagram showing the relationship among the coherence quantum E_coh, the preferred emission energy 2×E_coh, a corresponding wavelength, a broadened emission profile, and the atmospheric transparency window.

FIG. 4 is a coherence-matching and optical-response diagram showing a coherence length associated with diode emission, a cavity thickness matched to that coherence length, a Lorentzian emission characteristic, an Airy-type cavity-shaped response, and a narrowed sky-coupled angular output.

FIG. 5 is a reflector-operation diagram showing a reflector or metasurface structure, a downward radiation component, a phase-reversal boundary, suppression or cancellation of downward flux, and redirection of radiative power upward toward the sky.

FIG. 6 is a fabrication flow diagram showing representative steps including graphene growth, dry transfer, mesa lithography, cavity patterning, reflector deposition, thermocompression bonding, and formation of a finished device.

FIG. 7 is an electrical output and control diagram showing one or more thermoradiative devices, an output capacitor, a converter, a phase-gating controller, an eight-tick timing input, a delta-ledger watchdog, a threshold comparator, and a regulated electrical output.

FIG. 8 is a module and package diagram showing a tile-format embodiment including multiple thermoradiative generators, an interconnect network, a thermal spreader, a converter module, an output connector, and a mounting or enclosure structure.

FIG. 9 is a performance diagram showing representative power-density data, efficiency data, directionality information, and a benchmark comparison between the disclosed device and prior thermoradiative technologies.

FIG. 10 is a reliability and failure-mode diagram showing accelerated aging results, thermal-cycling results, representative failure mechanisms including voiding, diffusion, and oxidation, and associated detection and mitigation pathways.

### DETAILED DESCRIPTION OF THE INVENTION

Reference will now be made in detail to representative embodiments of the disclosed invention, examples of which are illustrated in the accompanying figures. Wherever possible, the same reference numerals are used throughout the drawings to refer to the same or like parts. The figures are schematic and illustrative unless expressly stated otherwise and are not necessarily drawn to scale. The embodiments described herein are exemplary and are provided to enable those skilled in the art to make and use the invention. Unless expressly stated otherwise, no described feature is required in every embodiment, and no embodiment is limited to the precise materials, dimensions, sequences, or operating conditions expressly set forth, except as may be recited in the claims.

The core of the present disclosure is a night-sky thermoradiative generator in which a graphene/hexagonal-boron-nitride/graphene resonant-tunnelling diode is configured for mid-infrared emission, an optical cavity is matched to the coherence characteristics of that emission, and a sky-facing reflector or metasurface directs emitted radiation into the atmospheric transparency window so that ambient heat may be converted into electrical output during nighttime operation. In preferred embodiments, the disclosed architecture is E_coh-matched, wherein E_coh=phi\hat{ }2-5 is structurally forced, the preferred peak emission energy is 0.18 eV=2×E_coh=2phi\hat{ }2-5, and the cavity thickness is matched to the coherence length of the diode emission according to t_cavity=L_E_coh=3.2 micrometers. The disclosure further treats the preferred 0.18 eV value as the smallest even-integer multiple of E_coh whose broadened emission lies in the useful atmospheric window under the disclosed lineshape, and further treats the cavity-thickness equality relation as a load-bearing design rule of the preferred architecture rather than as an arbitrary tuning choice.

As used herein, the term “thermoradiative generator” refers to a device that produces electrical power by radiative exchange from a warmer body to a colder radiative sink, including but not limited to a night sky. The term “resonant-tunnelling diode” or “RTD” refers to a multilayer electronic structure in which charge carriers tunnel through a barrier under resonant conditions to support a characteristic emission and electrical response. The term “coherence length” refers to a characteristic length associated with the spontaneous emission of the diode, and in embodiments may be determined from an emission spectrum by measuring a spectral linewidth (e.g., full width at half maximum Delta lambda around a peak wavelength λ0, or an equivalent linewidth in frequency units) and computing a coherence length that is inversely related to the linewidth (for example, L_coh≈λ0\hat{ }2 /(πDelta lambda), or an equivalent expression). In embodiments, a cavity thickness is “matched to,” “equal to,” or “selected in relation to” the coherence length when the cavity thickness is within a predetermined tolerance band of the coherence length, such as within +/−20%, +/−10%, or ±5% of L_coh, or when an objective coupling metric meets a stated acceptance criterion. The term “atmospheric transparency window” refers to a wavelength band, preferably the 8-14 micrometer band, through which emitted radiation can couple efficiently to the night sky. As used herein, phi (phi) refers to the golden ratio (1+√5)/2. The term “directionality factor” refers to a measure of preferential radiative emission into a desired angular range, such as upward emission toward the sky, and may be computed from angularly resolved radiance relative to an isotropic or Lambertian reference. The phrase “direct at least 80% of emitted radiation skyward” refers, in embodiments, to an angularly integrated radiative power or radiance over a sky-facing hemisphere divided by a total hemispherical emission (or other stated normalization), as measured by a goniometric radiance measurement, integrating-sphere method with angular masking, or an equivalent far-field measurement. The term “ledger-neutral extraction” refers to an electrical extraction mode, in embodiments that include such circuitry, in which output switching is coordinated so as to preserve a defined balance condition across a multi-phase cycle.

Unless the context clearly indicates otherwise, equations and numeric relations presented herein are provided in plain text form and may describe structural, physical, operational, or preferred design relationships. Such equations are not intended to import limitations into the claims except to the extent expressly recited in a claim. Likewise, references to preferred values, preferred ranges, or preferred materials are intended to provide written-description support and fallback positions and do not, by themselves, exclude broader disclosed embodiments.

Material that may be incorporated by reference from any related application, publication, or other document is incorporated only for such background, definitional, or supplementary disclosure as may be permitted and useful in understanding exemplary embodiments of the present disclosure. To the extent any incorporated material is inconsistent with the present specification, the present specification governs. No incorporated material should be understood as importing a limitation into any claim unless the limitation is expressly recited in the claim, and no statement in incorporated material should be read as redefining, disclaiming, or narrowing the invention as set forth in the present specification.

The present disclosure supports the invention in device, method, and system forms. In device form, the invention may be embodied as a thermoradiative generator including the resonant-tunnelling diode, the optical cavity, and the reflector arranged for nighttime radiative exchange with a colder sky-facing sink. In method form, the invention may be embodied as a process of thermally coupling the generator to ambient heat, radiatively coupling emitted photons into the atmospheric window, and extracting electrical output generated by the radiative exchange. In system form, the invention may be embodied as one or more thermoradiative generators electrically coupled through an interconnect network to an output interface and, in some embodiments, to a converter or regulated output stage. These forms of the invention may share common structural features, operational relations, and preferred dimensions as described herein.

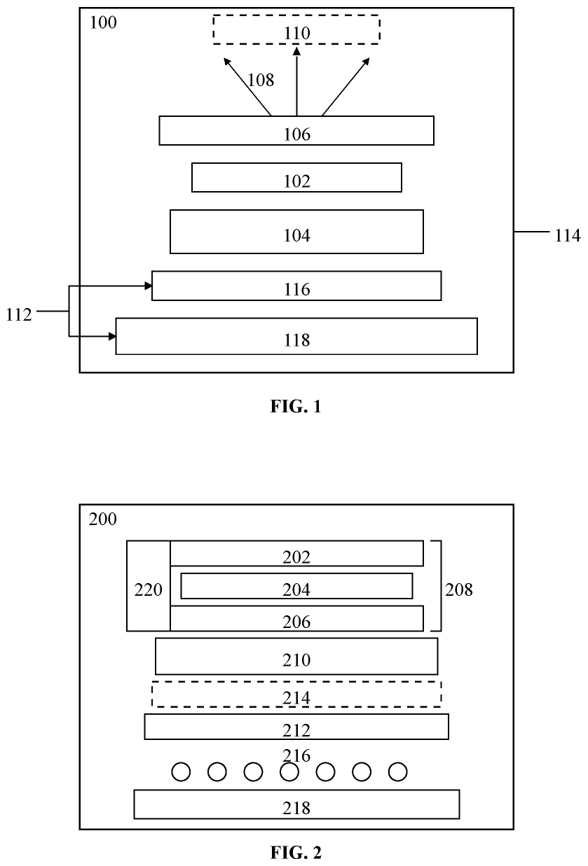

Referring first to FIG. 1, a thermoradiative generator assembly 100 includes a graphene/hexagonal-boron-nitride/graphene resonant-tunnelling diode stack 102, a patterned optical cavity 104, and a sky-facing reflector or metasurface 106. In operation, ambient heat is supplied through an ambient heat input path 112 and through a thermal interface region 116 to the active device structure, while emitted radiation is directed along upward emission path 108 toward the atmospheric transparency window 110. Electrical output is taken from electrical output node 114, and the overall assembly may be supported by a substrate or package body 118. FIG. 1 thus illustrates the principal physical kernel of the invention: a mid-infrared RTD emitter, a coherence-related cavity, and an upward-directing radiative structure arranged to produce electrical output from nighttime radiative exchange.

Referring to FIG. 2, a representative device stack 200 includes a first graphene layer 202, a hexagonal boron nitride barrier 204, and a second graphene layer 206 defining a resonant-tunnelling region 208. A patterned SiO2 cavity 210 is disposed in optical relation to the emitting structure, and a reflector layer 212 is positioned with an air gap 214 in embodiments using a reflector configuration such as a Salisbury-screen arrangement. Thermal coupling may be provided through indium or InSn bumps 216 to a heat spreader 218, such as an AlN spreader, while electrical access may be provided through one or more electrical contact regions 220. Although the illustrated embodiment shows a presently preferred layer arrangement, other embodiments may vary in packaging or interconnect details while preserving the disclosed RTD-cavity-reflector architecture.

The active emitter preferably comprises a graphene/hexagonal-boron-nitride/graphene resonant-tunnelling diode. In a preferred implementation, the hBN barrier thickness is about 1.6 nm, although broader embodiments may employ barrier thicknesses that preserve resonant tunnelling and mid-infrared emission in the disclosed operating band. The disclosure further supports embodiments in which the barrier thickness is less than or equal to about 2 nm, and more particularly within a range of about 1.2-2.0 nm. In preferred embodiments, the RTD exhibits a peak wavelength of about 6.9 micrometers, a linewidth of about 0.46 micrometers, and a quality factor Q of about 15.

In preferred embodiments, the graphene/hexagonal-boron-nitride/graphene stack with barrier thickness d_b=1.6 nm supports resonant tunnelling when k=pi/d_b. In representative embodiments, the resonant-tunnelling diode exhibits a peak wavelength of about 6.9 micrometers, a linewidth of about 0.46 micrometers, a quality factor Q of about 15, and a preferred peak emission energy of 0.18 eV=2×E_coh=2phi\hat{ }-5. Broader embodiments may employ barrier thicknesses and resonant-tunnelling conditions that preserve the disclosed mid-infrared operating band, but the 1.6 nm preferred structure provides the strongest supported implementation.

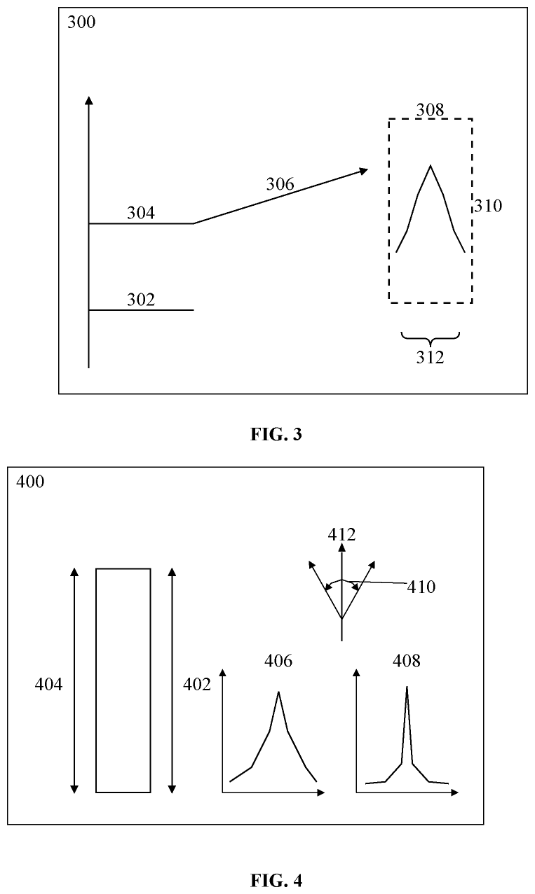

Referring to FIG. 3, an energy-alignment diagram 300 presents a preferred coherence-linked energy relation in which E_coh level 302 corresponds to E_coh=phi\hat{ }-5 and preferred level 304 corresponds to 2×E_coh. In preferred embodiments, E_coh is about 0.090 eV and the preferred peak emission energy is 0.18 eV=2×E_coh=2phi\hat{ }-5. Corresponding wavelength marker 306 lies in a range that, when the diode emission profile 310 is broadened according to the disclosed Q-factor annotation 312, couples usefully into atmospheric transparency window 308. The disclosed preferred 0.18 eV value is presented as the smallest even-integer multiple of E_coh whose broadened emission lies in the useful atmospheric window under the disclosed lineshape.

In the preferred architecture, the coherence quantum E_coh=phi\hat{ }-5 is structurally forced, and the preferred peak emission energy of 0.18 eV=2×E_coh is exactly two coherence quanta. The disclosure further presents this relation as not a tuned coincidence. Rather, the preferred 0.18 eV value is the smallest even-integer multiple of E_coh whose broadened emission lies within the useful atmospheric transparency window under the disclosed lineshape. In broader fallback embodiments, the resonant-tunnelling diode may be configured for peak emission in a mid-infrared band coupled to the atmospheric window, for example in an energy range of about 0.15-0.25 eV, while the preferred and most strongly supported embodiment remains the 0.18 eV=2×E_coh implementation.

Referring to FIG. 4, a preferred coherence-matching FIG. 400 illustrates an emission coherence length 402 and a cavity thickness 404 selected in relation to that coherence property. In the most preferred embodiment, the cavity thickness equals the coherence length of the diode emission, such that t_cavity=L_E_coh=3.2 micrometers. The disclosure treats this matching relation as a load-bearing design rule of the preferred architecture. The cavity acts to transform a broader Lorentzian response 406 into a narrower Airy-type response 408, thereby reducing angular spread 410 and improving directional sky-coupled output 412.

In preferred embodiments, the cavity converts the emission spectrum from a broad Lorentzian response into an Airy lineshape having a finesse of about 39, thereby reducing angular spread while substantially conserving radiance. In broader embodiments, the cavity dimension may be selected to improve spectral coupling, angular coupling, or both spectral coupling and angular coupling of emitted radiation into the atmospheric window even where exact equality to the coherence length is not imposed. However, the strongest and most preferred embodiment remains the equality relation t_cavity=L_E_coh=3.2 micrometers. In a preferred implementation, the cavity comprises a patterned SiO2 structure having a square-lattice period of about 2.5 micrometers, pillar dimensions on the order of about 200 nm, and a thickness of about 3.2 micrometers, with a representative leaky mode near about 10.3 micrometers and a group index of about 3.1.

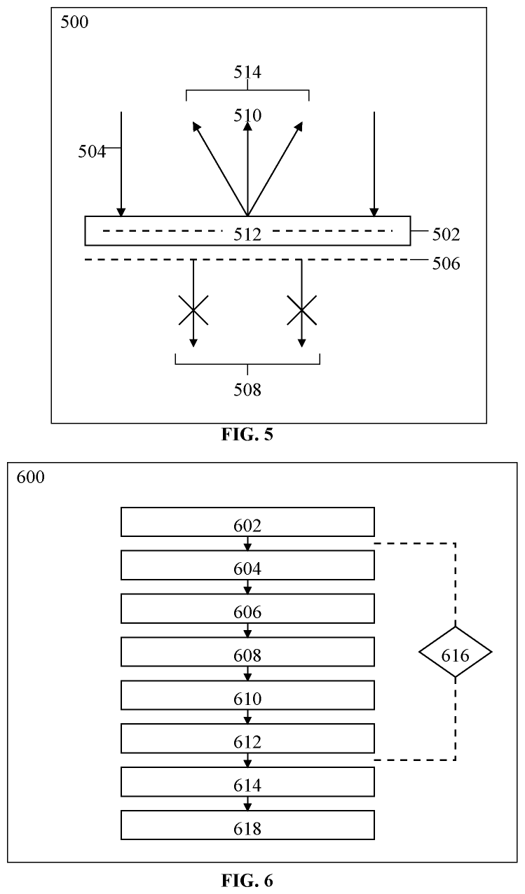

Referring to FIG. 5, a reflector FIG. 500 includes a reflector or metasurface 502 configured to act on incident downward radiation 504 at a phase-reversal boundary 506 so as to suppress or cancel downward flux 508 and redirect radiative output upward at 510 toward the atmospheric window coupling region 514. In preferred embodiments, the reflector includes an emissivity band characteristic 512 supporting strong coupling across the 8-14 micrometer range.

In preferred embodiments, the reflector comprises a TiN Salisbury-screen structure in which the TiN reflector imposes a pi-phase reversal, cancelling downward flux so that about 86% of total radiance exits upward. In representative embodiments, the TiN layer has a thickness of about 80 nm and is separated by an air gap of about 200 nm from the underlying cavity structure, with emissivity of at least about 0.93 across the 8-14 micrometer range. Broader embodiments may use reflector configurations that preserve upward directional emission, and in intermediate fallback embodiments the reflector is configured to direct at least a majority of emitted radiation skyward, more preferably at least about 80% skyward. In preferred embodiments, the resulting directionality factor is about 5.6.

In embodiments, spectral and/or hemispherical emissivity may be determined by FTIR-based spectral emissivity measurement together with angular integration over a hemisphere, or by an equivalent radiometric method.

Referring again to FIGS. 1 and 2, the disclosed thermoradiative generator is configured to receive heat from an ambient environment and to reject radiative power toward a colder sky-facing sink. In representative embodiments, thermal interface region 116 and bumps 216 conduct heat from a supporting body, substrate, housing, or other ambient-coupled structure into the active thermoradiative stack. Heat spreader 218 distributes thermal input laterally and helps maintain a controlled junction temperature across the emitting area. This arrangement allows the device to operate from ambient or waste-heat sources without requiring active refrigeration or mechanically actuated tracking elements.

In preferred embodiments, thermal coupling is provided by indium or InSn bumps 216 coupled to an AlN heat spreader 218. A representative implementation uses sixty-four bumps having a characteristic dimension of about 64 micrometers. In preferred embodiments, the resulting thermal resistance is about 0.6 K cm\hat{ }2/W and the junction temperature rise is about 1.4 K. These values are representative and may vary in other embodiments, provided that the device maintains sufficiently low thermal impedance to support the disclosed nighttime thermoradiative operating mode.

Broader embodiments may use alternative thermal interfaces and heat spreaders while preserving the disclosed functionality. For example, the bump composition, spreader material, attachment technique, or package architecture may vary, provided that heat is transferred effectively to the active device and the radiative surface remains coupled to the sky-facing hemisphere. Such variations are subordinate to the disclosed RTD-cavity-reflector kernel and are not required in every embodiment.

Referring to FIG. 6, a representative fabrication flow 600 is now described. The illustrated sequence is a preferred make-and-use route and provides concrete enablement for forming a thermoradiative generator according to the present disclosure. Other fabrication sequences may be employed so long as they yield a structure preserving the disclosed resonant-tunnelling emitter, coherence-related cavity, and upward-directing reflector arrangement.

At graphene growth step 602, monolayer graphene is grown on copper by chemical vapor deposition. In a representative implementation, the growth temperature is about 1040 C using CH4/H2 flows of about 30/5 sccm. In preferred embodiments, the resulting graphene exhibits a Raman 2D full width at half maximum of about 27 cm\hat{ }−1. The quality of the graphene may be characterized before transfer as part of quality-control checkpoint 616.

At transfer step 604, the graphene is dry-transferred using support layers, for example PMMA/PVA supports, onto an epitaxial hexagonal boron nitride layer. A second graphene sheet is then aligned to complete the graphene/hBN/graphene stack. Alignment may be controlled so as to preserve resonant-tunnelling performance in the finished device.

At mesa lithography step 606, individual device mesas are defined. In a representative implementation, e-beam patterning is performed at about 100 keV and the stack is etched using O2/Ar reactive-ion etching at about 50 mTorr to isolate mesas having a representative lateral size of about 40 micrometers. Other mesa dimensions and lithography methods may be used in alternative embodiments.

At cavity patterning step 608, the optical cavity structure is formed. In a preferred implementation, a Ni shim embosses a SiO2 sol-gel layer and a CHF3 etch defines the patterned structure to a representative depth of about 3.2 micrometers. In preferred embodiments, critical-dimension non-uniformity is about plus or minus 2.8%. This step yields the coherence-related cavity geometry that supports the disclosed optical shaping and directional coupling behavior.

At reflector deposition step 610, the reflector layer is formed. In preferred embodiments, TiN is sputtered to a thickness of about 80 nm at about 300 C, and a sacrificial SiO2 layer is removed to form the air gap 214 associated with the preferred Salisbury-screen reflector architecture. Other reflector formation techniques may be used in broader embodiments, provided they preserve the disclosed directional radiative function.

At thermocompression bonding step 612, the device is bonded to the thermal support structure. In representative embodiments, InSn bumps are reflowed at about 170 C and pressed onto an AlN spreader at about 25 N/die. In preferred embodiments, X-ray inspection at quality-control checkpoint 616 shows a void fraction of less than about 1.5%. The resulting finished bonded device 614 may then be used individually or incorporated into a module-assembly branch 618. Although the foregoing describes a preferred fabrication route, broader embodiments may employ alternative dielectric patterning methods, alternative embossing or etching approaches, alternative conductor-deposition methods, or alternative bonding materials and conditions, provided that the resulting structure maintains the disclosed thermoradiative functionality. These variations should be treated as optional fabrication embodiments rather than as redefinitions of the core invention.

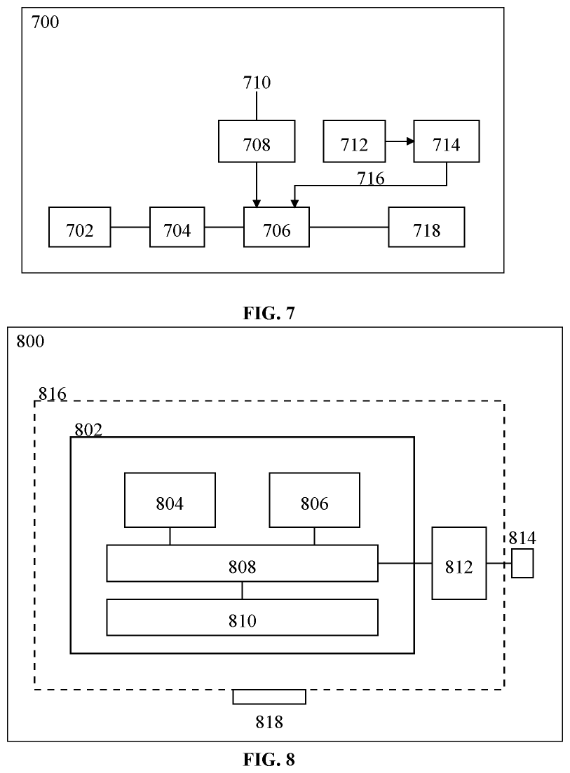

Referring to FIG. 7, an extraction/control architecture 700 may be coupled to one or more thermoradiative devices to collect generated electrical power and provide an output suitable for storage or load supply. In its broadest form, the electrical architecture may simply extract electrical output from a single RTD device or from multiple RTD devices and couple that output to an output capacitor 704, converter 706, or regulated output node 718. Thus, the present disclosure supports a fallback ladder extending from generic electrical extraction to synchronized extraction and, in preferred embodiments, to eight-tick synchronized extraction with monitored neutrality.

In some embodiments, the device output is combined in an RTD string 702. The string may comprise a single device, multiple devices in series, multiple devices in parallel, or mixed interconnection arrangements depending on the desired voltage and current characteristics. In a representative preferred embodiment, 180 diodes are connected in series to provide an open-circuit voltage of about 320 V, and a converter 706, such as a GaN boost converter operating at about 1 MHz and about 94% efficiency, supplies a regulated 5 V output at node 718. A representative 4 cm\hat{ }2 tile embodiment provides about 15.3 mW under stated night-sky conditions.

In preferred embodiments, electrical extraction is synchronized according to an eight-tick cadence. Phase-gating controller 708 receives an eight-tick timing input 710 and constrains switching events to permitted phase windows corresponding to phases kpi/4 for k=0 through 7. In preferred embodiments, the switching events of converter 706 are aligned to those permitted phase windows such that each extraction transfers an integer multiple of E_coh to output capacitor 704. The eight-tick cancellation identity further guarantees ledger neutrality over each complete cycle, according to sum from k=0 to 7 of exp(2piik/8)=0, implying delta C=0 over the full cycle.

Delta-ledger watchdog 712 monitors a balance quantity associated with the extraction process. In embodiments, the balance quantity comprises a measurable deviation in a stored-energy or charge-related state variable over a cycle or sub-cycle, such as a change in output-capacitor voltage, a computed change in stored charge on the output capacitor, an integrated current imbalance, or an equivalent electrical state proxy. Threshold comparator 714 compares the monitored quantity (for example an absolute value |delta|) to a programmed threshold value, and shutoff path 716 disables or interrupts converter operation when the monitored quantity exceeds the threshold. In preferred embodiments, the converter is disabled within one eight-tick cycle when imbalance exceeds the threshold.

Where multiple permitted phase windows are available, controller 708 may select a switching window satisfying one or more criteria including neutrality preservation, output target, efficiency target, or stability target. In embodiments, the monitored imbalance quantity may include a computed charge-imbalance proxy over a cycle (e.g., a Delta C proxy derived from capacitor state), but no particular proxy is required in every embodiment so long as a measurable state variable is monitored and compared to a threshold to control shutdown behavior as described herein.

Referring to FIG. 8, a representative module embodiment 800 includes a tile package 802 containing multiple thermoradiative generators, such as first generator 804 and second generator 806, interconnected through interconnect network 808. Thermal spreader 810 provides thermal distribution across the tile, and converter module 812 conditions the output for delivery through output connector 814. Enclosure 816 and mounting interface 818 may be provided to facilitate installation into a host structure, sensor platform, building element, or other application environment.

The module embodiment provides a practical bridge between the single-device architecture and product-level implementations. In some embodiments, the module is a tile-format unit configured for use as a standalone night-power component. In other embodiments, multiple modules may be arrayed across a larger surface. The module architecture remains subordinate to the core device invention, but provides important support for system claims, packaging claims, and practical deployment embodiments.

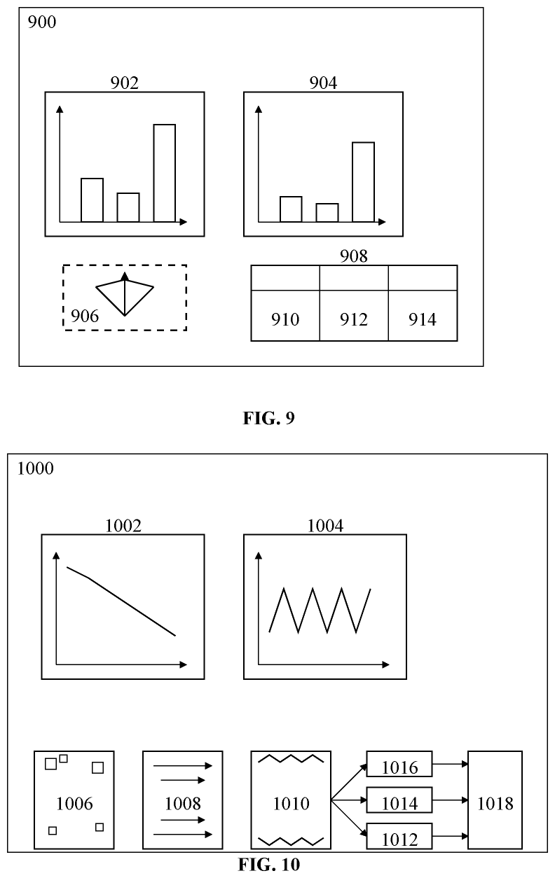

Referring to FIG. 9, the disclosed devices may be characterized under nighttime operating conditions representative of practical use. In a representative test condition, T_cell is about 300 K, T_sky is about 250 K, and delta T is less than or equal to about 50 K under clear night-sky conditions without auxiliary cooling. Under these conditions, representative measured outputs include an electrical power density of about 35 W/m\hat{ }2, an efficiency ratio eta/eta_Carnot of about 24%, electrical efficiency eta_elec of about 0.83, a string open-circuit voltage of about 320 V, a per-string V_oc of about 1.78 V, a fill factor of about 0.69, and a directionality factor D of about 5.6.

In embodiments, the reported power density and efficiency values are obtained under stated ambient and sky conditions including an ambient-side temperature measured at or near the device thermal interface, a sky-facing radiative sink temperature estimated from an infrared sky temperature measurement or a standardized clear-sky model, and electrical output measured at an output node under a defined load condition (e.g., maximum power point tracking, a resistive load sweep, or a regulated-converter output), such that the reported W/m\hat{ }2 values are normalized to an emitting area of the thermoradiative generator or module.

Performance FIG. 900 may include power-density plot 902, efficiency plot 904, directionality annotation 906, and benchmark table 908 comparing the disclosed architecture to prior-art InSb reference 910 and prior-art HgCdTe reference 912. Present-work marker 914 identifies the disclosed embodiment. In representative comparisons, the disclosed device exhibits about 35 W/m\hat{ }2 versus about 13 W/m\hat{ }2 for InSb and about 9 W/m\hat{ }2 for HgCdTe, and about 24% of Carnot efficiency versus about 8% and about 6%, respectively.

A brief synthesis of experimental support may be stated as follows: in representative embodiments and test conditions described herein, the disclosed thermoradiative architecture combines a graphene-based resonant-tunnelling emitter, coherence-related cavity shaping, and directional sky coupling to achieve nighttime electrical output together with benchmark improvement relative to representative prior-art narrow-gap thermoradiative materials. The foregoing results are provided as illustrative support for disclosed embodiments and operating regimes and should not be understood as requiring that every embodiment achieve every stated numerical result.

Unless expressly stated otherwise, the performance metrics described herein may be determined under representative measurement conditions in which ambient-side temperature, sky-facing sink temperature, emitting area, and electrical load condition are defined or measured in a consistent manner. In embodiments, power-density values may be normalized to an emitting area of the thermoradiative generator or module, angular or directional values may be obtained from angularly resolved radiance measurements or equivalent far-field measurements, and electrical output values may be measured at a direct output node, under a defined load condition, or after regulated conversion, provided that the measurement basis is consistent for the reported result. Accordingly, the reported values provide concrete support for disclosed embodiments while allowing alternative but technically equivalent measurement protocols in other embodiments.

In some embodiments, acceptable performance may be characterized by one or more thresholds, including upward radiance fraction, power density, efficiency, directionality, or reliability. Such acceptance criteria are provided as non-limiting examples for verification and optional fallback positions, and are not required in every embodiment and should not be treated as replacing the structural kernel of the invention.

Referring to FIG. 10, reliability FIG. 1000 may summarize accelerated environmental testing and representative failure-mode analysis. In one representative accelerated-aging test, humidity/temperature aging result 1002 corresponds to 85 C and 85% relative humidity over 1000 hours, with a measured power reduction of about 2.3%. Thermal-cycling result 1004 may correspond to cycling between about −40 C and about 80 C for 300 cycles with no delamination observed.

Representative failure mechanisms include indium voiding mode 1006, Au diffusion mode 1008, and TiN oxidation mode 1010. Detection paths may include X-ray CT detection path 1012, SIMS detection path 1014, and FTIR detection path 1016. Representative mitigation pathway 1018 may include one or more of Sn capping, Ni barrier layers, or ALD Al2O3 protection. These failure pathways and mitigation techniques provide additional implementation detail supporting manufacture and long-term deployment.

In some embodiments, lifetime may be projected by Arrhenius analysis. In a representative example, an activation energy E_a of about 0.76 eV supports a projected lifetime of at least about 15 years at 25 C for embodiments corresponding to the tested structures and conditions. This lifetime statement is a projection derived from accelerated testing rather than a direct full-duration field measurement, and different embodiments, materials, package constructions, or operating environments may yield different lifetimes.

In some embodiments, the disclosure is supported by machine-checked formal verification of specific structural propositions. Such formal verification is not required to practice the invention and is not a substitute for make-and-use disclosure. Rather, it provides an additional credibility anchor for specific relations used in preferred embodiments.

Representative formal support includes propositions identified in the source materials as coherence_exponent_eq_5, coherence_exponent_unique, D_3_fibonacci_constraint, sum_8_phases_eq_zero, ledger_neutral, zero_imbalance_safe, phi_ratio_optimal, integer_chronon_positive, phi_sq_eq_phi_add_one, phi_pos, one_lt_phi, and E_coh_pos. In the context of the present disclosure, these propositions support, among other things, the preferred framing that E_coh=phi\hat{ }-5 is structurally determined, that the disclosed coherence relation is tied to the stated dimensional/Fibonacci constraint, that eight-phase cancellation supports the preferred synchronized extraction architecture, and that preferred extraction events may be treated as integer-multiple E_coh transfers.

The disclosed architecture provides several advantages over prior thermoradiative technologies. In representative embodiments, the device achieves approximately 2.6 times the power density of representative InSb systems and approximately 3 times the Carnot-fraction efficiency of representative prior narrow-gap systems. The graphene-based RTD structure reduces the dominant Auger-loss limitations of prior systems, the cavity-reflector architecture provides strong sky-coupled directional emission without moving parts, and the device may be fabricated using CMOS-compatible materials without mercury or cadmium. Additional advantages include compact tile-format implementation, wide operating temperature tolerance, and, in preferred embodiments, structurally forced coherence-linked emission energy together with eight-tick ledger-neutral extraction.

Although the invention is defined by the disclosed thermoradiative device architecture rather than by any one commercial use, the device may be incorporated into a variety of downstream systems. Representative examples include night-time sensor nodes, desert telecom repeaters, spacecraft radiators or eclipse-power systems, polar-night IoT beacons, building-integrated night-power systems, and agricultural monitoring platforms. These downstream embodiments are illustrative only, are subordinate to the core device invention, and should not be understood as limiting the invention to any particular end-use environment, deployment scenario, scale, or commercial configuration.

What is claimed is:

1. A thermoradiative generator comprising: a graphene/hexagonal-boron-nitride/graphene resonant-tunnelling diode stack having a hexagonal-boron-nitride barrier thickness of less than or equal to 2 nm and configured for a peak emission energy equal to an integer multiple of a coherence quantum E_coh in an energy range of 0.15-0.25 eV; an optical cavity optically coupled to the resonant-tunnelling diode and having a cavity thickness selected in relation to a coherence length of emission from the resonant-tunnelling diode; and a reflector configured to direct at least 80% of emitted radiation skyward; wherein the thermoradiative generator is configured to generate electrical power from ambient heat by radiative exchange with a colder sky-facing sink.

2. The thermoradiative generator of claim 1, wherein emitted radiation from the thermoradiative generator is directed into an atmospheric transparency window comprising an 8-14 micrometer atmospheric window.

3. The thermoradiative generator of claim 1, wherein the integer multiple is an even integer multiple.

4. The thermoradiative generator of claim 1, wherein the coherence length is determined from an emission spectrum by measuring a spectral linewidth and computing the coherence length as inversely related to the measured linewidth.

5. The thermoradiative generator of claim 1, wherein a coherence quantum E_coh is given by E_coh=phi\hat{ }-5.

6. The thermoradiative generator of claim 5, wherein the peak emission energy is about 0.18 eV=2×E_coh=2phi\hat{ }-5.

7. The thermoradiative generator of claim 1, wherein the optical cavity comprises a patterned SiO2 structure having a square-lattice period of 2-3 micrometers and pillar dimensions on the order of 150-250 nm.

8. The thermoradiative generator of claim 1, wherein the cavity thickness is matched to the coherence length of emission from the resonant-tunnelling diode by being within +/−10% of the coherence length.

9. The thermoradiative generator of claim 1, wherein the reflector comprises a TiN Salisbury-screen reflector having emissivity of at least 0.9 across an 8-14 micrometer range.

10. The thermoradiative generator of claim 9, wherein the TiN reflector has a thickness of 60-100 nm and is separated from the optical cavity by an air gap of 150-250 nm.

11. The thermoradiative generator of claim 1, wherein the hexagonal-boron-nitride layer has a thickness of 1.2-2.0 nm.

12. The thermoradiative generator of claim 1, wherein the thermoradiative generator achieves at least 20% of the Carnot limit for a delta T less than or equal to 50 K.

13. A method of generating electrical power from ambient heat, the method comprising:
providing a graphene/hexagonal-boron-nitride/graphene resonant-tunnelling diode configured for mid-infrared emission;
optically coupling the resonant-tunnelling diode to an optical cavity having at least one cavity dimension selected in relation to coherence characteristics of emission from the resonant-tunnelling diode;
directing emitted radiation skyward with a reflector;
thermally coupling the resonant-tunnelling diode to ambient heat; and
extracting electrical power generated by radiative exchange between the resonant-tunnelling diode and a colder sky-facing sink.

14. The method of claim 13, wherein extracting electrical power comprises synchronizing extraction events according to an eight-tick cadence, transferring energy in integer multiples of E_coh, and disabling extraction when an imbalance quantity exceeds a threshold.

15. The method of claim 13, wherein the resonant-tunnelling diode is configured for a peak emission energy of about 0.18 eV.

16. The method of claim 13, wherein an optical cavity thickness is within +/×10% of a coherence length of emission from the resonant-tunnelling diode.

17. A thermoradiative power system comprising:
one or more thermoradiative generators according to claim 1;
an interconnect network coupled to the one or more thermoradiative generators; and
an output interface configured to provide electrical power from the one or more thermoradiative generators.

18. The thermoradiative power system of claim 17, wherein the one or more thermoradiative generators are connected in series and the thermoradiative power system produces at least 10 mW from an area of about 4 cm\hat{ }2 under clear night-sky conditions at about 300 K.

19. The thermoradiative power system of claim 17, wherein the thermoradiative power system comprises at least 100 thermoradiative generators connected in series to provide an open-circuit voltage of at least 200 V.

20. The thermoradiative power system of claim 17, further comprising a GaN boost converter configured to provide regulated DC output with an efficiency of at least 90%.
